(19) United States
(12) Patent Application Publication
(10) Pub. No.: US 2014/0265758 A1
(43) Pub. Date: Sep. 18, 2014

(54) THREE SIDE SILVER FRIT ON HEATED GLASS

(71) Applicant: HUSSMANN CORPORATION, St. Louis, MO (US)

(72) Inventor: Craig S. Reichert, Bridgeton, MO (US)

(73) Assignee: HUSSMANN CORPORATION, St. Louis, MO (US)

(21) Appl. No.: 13/798,535

(22) Filed: Mar. 13, 2013

(51) Int. Cl. A47F 3/04; H01R 4/00

(52) U.S. Cl. CPC A47F 3/043; H01R 4/00; A47F 3/0434
USPC 312/138.1; 428/192; 428/194; 174/84 R

(57) ABSTRACT

A heatable glass assembly includes a pane of glass having a first surface, a top edge, a bottom edge, and a side edge between the top edge and the bottom edge and having a length L. A pyrolytic coating is applied to a portion of the first surface. A conductive paste is applied along or adjacent to at least a part of the top edge, the bottom edge, and the side edge. The conductive paste associated with the top edge is in electrical communication with a portion of the conductive paste associated with the side edge, and the conductive paste associated with the bottom edge is in electrical communication with another portion of the conductive paste associated with the side edge. The conductive paste associated with the top edge and associated with the bottom edge is in electrical contact with the pyrolytic coating.

### BACKGROUND

The present invention relates to refrigerated merchandisers, and more particularly to heated glass panes for doors of refrigerated merchandisers.

Refrigerated merchandisers are used by grocers to store and display food items in a product display area that must be kept at a predetermined temperature. These merchandisers generally include a cabinet with an integrated refrigeration unit and have multiple shelves supported within the product display area. Doors positioned along the front side of the merchandiser separate the product display area from the ambient external conditions and allow for consumer access to the contents within. The doors typically include one or more panes of glass configured to minimize heat transfer while providing unimpaired visual access to the product display area.

Condensation can form on the interior face of the glass doors as ambient air with a certain moisture content contacts a surface that has been cooled below the air's dew point. For example, the pane of glass adjacent the refrigerated interior will likely be below the dew point of the store side (ambient) air. Opening the door will expose the face of this relatively cold pane to the ambient air, resulting in condensation (e.g., “fogging”) on this interior surface. For that reason, the interior pane of glass normally includes an electrically activated pyrolytic coating on the inner surface. Resistance heating due to the current generated through the coating increases the temperature of the glass and reduces the condensation formed when the door is opened.

To provide electricity to the pyrolytic coating, a conductive paste is applied along or adjacent to the top and bottom edges of the glass pane. This conductive paste is ceramic-based and includes silver particles to provide electrical conductivity. Known also as silver frit (or silver bus bar), the paste is connected by wires to a source of electricity to complete the electrical circuit. The flexible wire connection and routing of the wires along the side edge of the glass pane is often a source of system failure during operation.

### SUMMARY

In one construction a heatable glass assembly includes a pane of glass having a first surface, a top edge, a bottom edge, and a side edge between the top edge and the bottom edge and having a length L. A pyrolytic coating is applied to a portion of the first surface. A conductive paste is applied along or adjacent to at least a part of the top edge, the bottom edge, and the side edge. The conductive paste associated with the top edge is in electrical communication with a portion of the conductive paste associated with the side edge, and the conductive paste associated with the bottom edge is in electrical communication with another portion of the conductive paste associated with the side edge. The conductive paste associated with the top edge and associated with the bottom edge is in electrical contact with the pyrolytic coating.

In one construction a refrigerated merchandiser includes a case defining a product display area and a door coupled to the case and enclosing a portion of the product display area. The door includes a frame and a glass assembly coupled to the frame. The glass assembly includes a pane of glass having a first surface, a top edge, a bottom edge, and a side edge between the top edge and the bottom edge and having a length L. A pyrolytic coating is applied to a portion of the first surface. A conductive paste is applied along or adjacent to at least a part of the top edge, the bottom edge, and the side edge. The conductive paste associated with the top edge is in electrical communication with a portion of the conductive paste associated with the side edge and the conductive paste associated with the bottom edge is in electrical communication with another portion of the conductive paste associated with the side edge. The conductive paste associated with the top edge and associated with the bottom edge is in electrical contact with the pyrolytic coating.

In a method of assembling a heatable glass assembly, in which the glass pane includes a surface having a pyrolytic coating, a top edge, a bottom edge, and a side edge between the top edge and the bottom edge and having a length L, the method includes applying a conductive paste along or adjacent to at least a part of the top edge and applying a conductive paste along or adjacent to at least a part of the bottom edge. The method also includes removing a portion of the pyrolytic coating near the side edge. The method further includes applying a conductive paste along or adjacent to a portion of the side edge and in electrical communication with the conductive paste associated with the top edge, and applying a conductive paste along or adjacent to a portion of the side edge and in electrical communication with the conductive paste associated with the bottom edge.

Other aspects of the invention will become apparent by consideration of the detailed description and accompanying drawings.

### BRIEF DESCRIPTION OF THE DRAWINGS

FIG. 1 is a perspective view of a refrigerated merchandiser embodying the present invention.

FIG. 2 is a perspective view of a door of the refrigerated merchandiser of FIG. 1.

FIG. 3 is a partial section view of the glass panes of the door of FIG. 2.

FIG. 4 is a plan view of a pane of glass of the door of FIG. 2 having a pyrolytic coating.

FIG. 5 is a partial view of a section of the pane of glass of FIG. 4

FIG. 6 is a section view of the door taken along line 6-6 of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIG. 1 illustrates a refrigerated merchandiser 100 including a cabinet 110 that defines an interior space or product display area 114. The product display area 114 is cooled by a refrigeration unit (not shown), the selection and placement of which will be readily appreciated by those of ordinary skill in this art. Adjustable shelves 118 within the product display area 114 are supported by a back wall 122 of the cabinet 110 for supporting product. As illustrated, a cabinet casing 126 along a front face 128 of the cabinet 110 surrounds and supports doors 130 that provide ingress to the product display area 114.

With reference to FIGS. 2 and 3, each door 130 has a door frame 134 and a handle 138 for opening and closing the door 130. A hinge 142 facilitates rotational movement of the door between a closed position and an open position. Alternatively, the door 130 may translate, or slide, in a track (not shown) in a plane substantially parallel to the front face 128 (FIG. 1). A glass assembly 146 separates the product display area 114 from air in the ambient environment 148 surrounding the refrigerated merchandiser 100. The terms “ambient air” and “ambient environment” are meant to include air adjacent and external to the front face 128 of the refrigerated merchandiser 100 and may include, for example, air within a grocery store or other retail setting, or outside air if the merchandiser 100 is outside a building.

FIG. 3 shows that, the glass assembly 146 includes a first or exterior glass pane 150 that is positioned adjacent the ambient environment 148, a second or interior glass pane 160 that is positioned adjacent the product display area 114, and a third or intermediate glass pane 170 that is positioned between the exterior glass pane 150 and the interior glass pane 160. In some constructions, the glass assembly 146 may include more than three glass panes (i.e., more than one intermediate glass pane 170).

The exterior glass pane 150 includes a first surface 151 that faces away from the product display area 114 and that is exposed to the ambient environment 148 and a second surface 152 opposite the first surface 151 that faces toward the product display area 114. The exterior glass pane 150 is formed of a heat absorbing glass, which absorbs a significant quantity of incident infrared radiation from the ambient environment 148 and consequently reduces the amount of infrared radiation transmitted through the glass. The term “heat-absorbing glass” means glass that is specifically constructed for such a purpose, and includes glass containing quantities of ferrous iron or other material selected to provide a similar effect. The term “radiation” encompasses radiation across the electromagnetic spectrum, including infrared, visible light, and ultraviolet radiation. Specifically, the heat absorbing glass pane 150 absorbs approximately 35-55% of incident infrared radiation or heat from the ambient environment 148 while allowing approximately 70-90% of visible light to be transmitted. Other ranges of both absorption and transmittance for the exterior glass pane 150 are possible and considered herein. Absorbed radiation retained within the glass structure of the exterior glass pane 150 generates heat, which raises the temperature of the exterior glass pane 150, and specifically the temperature of the first surface 151, above the dew point of the ambient environment 148.

The intermediate glass pane 170 is spaced apart from the exterior glass pane 150 and the interior glass pane 160. The intermediate glass pane 170 includes a first surface 171 that faces away from the product display area 114 and toward the exterior glass pane 150, and a second surface 172 that faces toward the product display area 114 and toward the interior glass pane 160. The intermediate glass pane 170 can be formed from any suitable glass material (e.g., annealed glass).

With continued reference to FIG. 3, the first surface 171 of the intermediate glass pane 170 includes a low emissivity (“low-e”) coating 182. The low-c coating 182 of the first surface 171 reflects a portion of the radiation that passes through the exterior glass pane 150 back in the direction of the exterior glass pane 150. A portion of this reflected radiation will be absorbed by and further raise the temperature of the exterior glass pane 150. As illustrated, the second surface 172 includes a low-e coating 184 that reflects a portion of radiation that has passed through the exterior glass pane 150, the low-e coating 182, and the glass structure of the intermediate glass pane 170, maximizing the potential radiation absorbed by the exterior glass pane 150 while minimizing the amount of radiation that reaches the product display area 114.

The interior glass pane 160 includes a first surface 161 that faces away from the product display area 114, and a second surface 162 that faces toward and is exposed to the product display area 114. The interior glass pane 160 is formed of tempered glass, which is heat-treated glass heated above the annealing temperature and rapidly cooled, forming an outer glass layer with compressive stresses surrounding an inner glass layer in tension. Tempered glass, when broken, fragments into relatively small pieces less likely to cause injury and is frequently used instead of annealed glass in applications requiring such safety.

The interior glass pane 160 includes a pyrolytic coating 180 affixed or applied on the first surface 161. The pyrolytic coating 180 provides resistance heating to the interior glass pane 160 via electrical power from a power source (not shown in FIG. 3) to which the pyrolytic coating 180 is connected. As illustrated, the pyrolytic coating 180 is affixed to the first surface 161, rather than the second surface 162 of the interior glass pane 160, to minimize the possibility of electrical shock to a consumer. The heat provided to the interior glass pane 160 by the pyrolytic coating 180 quickly removes or “de-fogs” condensation formed on the second surface 162 when the door 130 is opened.

Referring to FIG. 4, the interior glass pane 160 includes a top edge 204, a bottom edge 208, a first side edge 212, and a second side edge 216. The first side edge 212 can generally be described as having a vertical length L from the top edge 204 to the bottom edge 208. The pyrolytic coating 180 spans the first surface 161 from approximately the top edge 204 to approximately the bottom edge 208 and from approximately the first side edge 212 to approximately the second side edge 216.

A conductive ceramic-based paste 224, forming a top strip 228, extends along or adjacent to the top edge 204 from the first side edge 212 to a point P at or adjacent to the second side edge 216. The ceramic-based paste 224 can be one of many commercially used conducting pastes and can be, for example, a silver fit. The paste 224 also forms a bottom strip 232 extending along or adjacent to the bottom edge 208 from the first side edge 212 to a point P′ at or adjacent to the second side edge 216. The points P, P′ are located at or within approximately ⅛ inch from the second side edge 216. The top strip 228 and bottom strip 232 are in electrical communication with the pyrolytic coating 180.

A first side strip 236 of paste 224 further extends along or adjacent to the first side edge 212 from the top strip 228 to an end point 240. A second side strip 244 of paste 224 extends along or adjacent to the first side edge 212 from the bottom strip 232 to an end point 248. The first side strip 236 and the second side strip 244 are in electrical communication with the top strip 228 and bottom strip 232, respectively, i.e., the first side strip 236 and the top strip 228 form an electrical conductor, or bus bar, to provide electrical energy to one side (the top) of the pyrolitic coating 180 and the second side strip 244 and the bottom strip 232 form a bus bar providing electrical energy to the other side (the bottom) of the pyrolitic coating 180. At the same time, the side strips 236, 244 are spaced apart from the pyrolytic coating 180 such that no direct electrical contact between the strips 236, 244, and the coating 180 is made along the vertical length L between strip 228 and strip 232. The strips 228, 232, 236, and 244 are not limited to a specific width or thickness but generally have a width ranging from approximately 3/16 inch to approximately ¼ inch, and a thickness of from approximately 5 microns to approximately 20 microns.

The application of side strips 236 and 244 results in a combined length of conductive paste 224 along or adjacent to the side edge 212 of greater than 0.5L but less than L. Referring to FIG. 5, a gap 250 is thereby formed equal to the distance between the end point 240 and the end point 248. In some constructions, this distance ranges from approximately 1″ to approximately 2″ in length. The gap 250 provides connection points to the source of power. Specifically, the end points 240, 248 present terminals for a source of AC or DC power. For example, the end point 240 can be a connection to a positive terminal of the power source and the end point 248 can be a connection to a negative terminal of the power source. To facilitate this connection, a mating plug 260 with contacts 264, 268 overlies the end points 240, 248 and completes the electrical circuit. The mating plug 260 is constructed of a nonconducting material, such as plastic.

In operation, the source of AC or DC power is energized and applied through the mating plug 260 to the end points 240, 248. The continuous conductor formed from the first side strip 236 and the top strip 228 connected to the contact 264 and the continuous conductor formed from the second side strip 244 and the bottom strip 232 connected to the contact 268 provide an applied voltage to the pyrolytic coating 180. This applied voltage generates a current through the coating 180 resulting in resistance heating of the surface 161. The heated coating 180 heats the interior glass pane 160 to de-fog any condensation that forms on the second surface 162 of interior pane 160. Power can be supplied to the heated coating 180 continuously or at predetermined intervals.

To assemble a glass pane 160 with an operational pyrolytic coating as previously described, conductive paste 224 is applied along or adjacent to the top edge 204 and along or adjacent to the bottom edge 208 to form the aforementioned strips 228, 232. A portion of the pyrolytic coating 180, previously applied to the glass surface 161, is removed from an area adjacent the first side edge 212. Enough of the coating 180 is removed to permit application of a sufficient width of paste 224 adjacent to the first side edge 212 without creating a shorting path to the remaining coating 180 on the first surface 161. For example, from ¼ inch to ½ inch of the coating 180 may be removed along the first side edge 212. Conductive paste 224 is then applied along or adjacent a first portion of the side edge 212 in electrical communication with the top strip 228 and to an end point 240, and along or adjacent a second portion of the side edge 212 in electrical communication with the bottom strip 232 and to an end point 248. The mating plug 260 is then secured to the pane 160, connecting the end points 240, 248 with a source of power.

Referring to FIG. 6, the door frame 134 provides support for the glass assembly 146 and can be formed of a flexible polyurethane. The door frame 134 includes a body 190, an outer flange 194 that contacts the first surface 151 of the exterior glass pane 150, and an inner flange 198 that contacts the second surface 162 of the interior glass pane 160. The flanges 194, 198 are bonded to the respective contacting surfaces 151, 162 using a formulated coating that bonds the polyurethane to the glass surfaces. The formulation used is preferably Chemlok® 144 Primer manufactured by LORD Corporation and allows the glass to flex to a different degree than the polyurethane without breaking the bond formed between them.

The door frame 134 also includes an insert 300 that separates and spaces the exterior glass pane 150, the interior glass pane 160, and the intermediate glass pane 170 from each other and from the door frame 134. The insert 300 wraps around the perimeter of the glass panes 150, 160, 170, and includes an outer spacer 304 and an inner spacer 308. The spacers 304, 308 are sized to define a first space 312 between the exterior glass pane 150 and the intermediate glass pane 170, and a second space 316 between the interior glass pane 160 and the intermediate glass pane 170. The first and second spaces 312, 316 can have any suitable dimension (e.g., approximately 0.5″ between the second surface 152 of the exterior glass pane 150 and the first surface 171 of the intermediate glass pane 170, and between the second surface 172 of the intermediate glass pane 170 and the first surface 161 of the interior glass pane 160). The first and second spaces 312, 316 between the glass panes 150, 160, 170 can be filled with any suitable air or non-reactive gas (e.g., nitrogen). As will be appreciated by one of ordinary skill in the art, a relatively small space between glass panes 150, 160, 170 may result in greater heat transfer within the space, while a relatively large space may promote convection within the space.

An exterior portion 320 of spacer 304 engages the surface 152 of exterior pane 150 while an exterior portion 322 of spacer 308 engages the surface 161 of interior pane 160. Interior portions 324, 326 of spacers 304, 308 engage surface 171 and surface 172, respectively, of intermediate pane 170. A bridge 336 contacts the top and bottom edges 174, 176 of intermediate pane 170. A first projection 340 contacts the top and bottom edges 154, 156 of exterior pane 150 and a second projection 344 contacts the top and bottom edges 164, 166 of interior pane 160. Each of the spacers 304, 308 provides sealing contact between the door frame 134 and the glass panes 150, 160, 170 to limit infiltration of ambient air into the product display area 114. Each spacer 304, 308 can be filled with a desiccant 350 or other hygroscopic material, and is in fluid communication with one of the first and second spaces 312, 316 to attract and retain any moisture within the first and second spaces 312, 316. Aluminum tape 360 can be applied to the insert 300 to provide an additional barrier to moisture entering first and second spaces 312, 316.

A portion of the heat absorbed by the exterior glass pane 150 transfers to the door frame 134 and heats the door frame 134. Specifically, a portion of the heat absorbed by the exterior glass pane 150 will be transferred to the outer flange 194, and consequently to an exterior surface 370 of the door frame 134. As described above, heating the exterior glass pane 150, and in particular the first surface 151, as well as the exterior surface 370 of the door frame 134 above the dew point of the ambient environment 148 prevents formation of condensation on both surfaces.

The insert 300 is formed of a substantially flexible material (e.g., polypropylene) to provide a flexible partition between panes 150, 160, and 170, and the door frame 134. The exterior glass pane 150 expands in size as it is heated, and the flexibility of the door frame 134 and the insert 300 accommodates this expansion without producing excessive stresses within glass assembly 146. Additionally, the flexible nature of the door frame 134 and the insert 300, which positions and secures the intermediate glass pane 170 within the glass assembly 146, allows for relative movement between glass panes 150, 160, and 170. The flexible spacer 304, first projection 340, and bridge 336 allow for relative movement between the exterior glass pane 150 and the intermediate glass pane 170 due to expansion and retraction of exterior glass pane 150. Similarly, the flexible spacer 308, second projection 344, and bridge 336 allow for relative movement between the interior glass pane 160 and the intermediate glass pane 170 due to expansion and retraction of interior glass pane 160. This relative movement between glass panes 150, 160, and 170 further minimizes stresses within the glass assembly 146.

Various features and advantages of the invention are set forth in the following claims.

1. A heatable glass assembly comprising:
a pane of glass including
a first surface;
a top edge;
a bottom edge;
a side edge between the top edge and the bottom edge and having a length L;
a pyrolytic coating applied to a portion of the first surface; and
a conductive paste applied along or adjacent to at least a part of the top edge, the bottom edge, and the side edge, wherein the conductive paste associated with the top edge is in electrical communication with a portion of the conductive paste associated with the side edge and the conductive paste associated with the bottom edge is in electrical communication with another portion of the conductive paste associated with the side edge, and further wherein the conductive paste associated with the top edge and associated with the bottom edge is in electrical contact with the pyrolytic coating.

2. The assembly of claim 1, wherein the conductive paste applied along or adjacent to at least a part of the side edge is greater than 0.5L of the side edge.

3. The assembly of claim 2, wherein the conductive paste applied along or adjacent to at least a part of the side edge is greater than 0.9L, of the side edge.

4. The assembly of claim 1, wherein the conductive paste applied along or adjacent to at least a part of the side edge forms a gap.

5. The assembly of claim 4, wherein the gap has a length of between about 1 inch and about 2 inches.

6. The assembly of claim 1, further including a mating plug, wherein the conductive paste applied along or adjacent to at least a part of the side edge forms a first terminal point and a second terminal point, and wherein the mating plug couples the first terminal point and the second terminal point to a source of electricity.

7. The assembly of claim 1, wherein the conductive paste is a silver frit.

8. The assembly of claim 1, wherein the conductive paste applied along or adjacent to at least a part of the side edge has a thickness of between about 5 microns and about 20 microns.

9. A refrigerated merchandiser comprising:
a case defining a product display area;
a door coupled to the case and enclosing a portion of the product display area, the door including
a frame;
a glass assembly coupled to the frame, the glass assembly including
a pane of glass including
a first surface;
a top edge;
a bottom edge;
a side edge between the top edge and the bottom edge and having a length L;
a pyrolytic coating applied to a portion of the first surface; and
a conductive paste applied along or adjacent to at least a part of the top edge, the bottom edge, and the side edge, wherein the conductive paste associated with the top edge is in electrical communication with a portion of the conductive paste associated with the side edge and the conductive paste associated with the bottom edge is in electrical communication with another portion of the conductive paste associated with the side edge, and further wherein the conductive paste associated with the top edge and associated with the bottom edge is in electrical contact with the pyrolytic coating.

10. The assembly of claim 9, wherein the conductive paste applied along or adjacent to at least a part of the side edge is greater than 0.5L of the side edge.

11. The assembly of claim 10, wherein the conductive paste applied along or adjacent to at least a part of the side edge is greater than 0.9L of the side edge.

12. The assembly of claim 9, wherein the conductive paste applied along or adjacent to at least a part of the side edge forms a gap.

13. The assembly of claim 12, wherein the gap has a length of between about 1 inch and about 2 inches.

14. The assembly of claim 9, further including a mating plug, wherein the conductive paste applied along or adjacent to at least a part of the side edge forms a first terminal point and a second terminal point, and wherein the mating plug couples the first terminal point and the second terminal point to a source of electricity.

15. The assembly of claim 9, wherein the conductive paste is a silver frit.

16. The assembly of claim 9, wherein the conductive paste applied along or adjacent to at least a part of the side edge has a thickness of between about 5 microns and about 20 microns.

17. A method of assembling a heatable glass assembly, the glass pane including a surface having a pyrolytic coating, a top edge, a bottom edge, and a side edge between the top edge and the bottom edge and having a length L, the method comprising:
applying a conductive paste along or adjacent to at least a part of the top edge;
applying a conductive paste along or adjacent to at least a part of the bottom edge;
removing a portion of the pyrolytic coating near the side edge;
applying a conductive paste along or adjacent to a portion of the side edge and in electrical communication with the conductive paste associated with the top edge; and
applying a conductive paste along or adjacent to a portion of the side edge and in electrical communication with the conductive paste associated with the bottom edge.
